(19) United States
(12) Patent Application Publication
(10) Pub. No.: US 2008/0307188 A1
(43) Pub. Date: Dec. 11, 2008

(54) Management of Guest OS Memory Compression In Virtualized Systems

(75) Inventors: Peter A. Franaszek, Mount Kisco, NY (US); Dan E. Poff, Mahopac, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/758,715

(22) Filed: Jun. 6, 2007

(51) Int. Cl. G06F 12/08

(52) U.S. Cl. 711/171; 711/E12.016

(57) ABSTRACT

The present invention provides a system and method for managing compression memory in a computer system. This system includes a hypervisor having means for identifying a operating system having a plurality of memory pages allocated, means for counting the number of a plurality of memory pages allocated, and means for counting a number of free space pages in the compressed memory. The hypervisor further includes means for determining if the number of free space pages is less than a predetermined threshold, and means for increasing the number of free space pages if less than a predetermined threshold.

### BACKGROUND OF THE INVENTION

1. Field of the Invention

This invention generally relates to methods and apparatus for management of compressed memory and particularly to a hypervisor that controls a compressed memory system.

2. Description of Background

A development in computer organization is the use of data compression for the contents of main memory, that part of the random access memory hierarchy which is managed by the operating system (“OS”) and where the unit of allocation is a page.

A convenient way to perform this compression is by automatically compressing the data using special-purpose hardware, with a minimum of intervention by the software or operating system. This permits compression/decompression to be done rapidly, avoiding what might otherwise be long delays associated with software compression/decompression.

In compressed memory systems, a page may occupy a variable amount of physical memory space. For example, as described in the below mentioned related patent applications, pages occupy or share a variable number of fixed size blocks; pages may be of nominal 4K size and blocks of size 256 bytes. Generally, the number of such blocks occupied by a page will vary with its contents, due to changes in compressibility.

Typically, each cache line is compressed prior to being written into memory, using a standard sequential or a parallel compression algorithm. Examples of sequential compression include Lempel-Ziv coding (and its sequential and parallel variations), Huffman coding and arithmetic coding. See, for example, J. Ziv and A. Lempel, “A Universal Algorithm For Sequential Data Compression,” IEEE Transactions on Information Theory, IT-23, pp. 337 343 (1977) which is hereby incorporated by reference in its entirety. A parallel approach is described in U.S. Pat. No. 5,729,228, entitled Parallel Compression and Decompression Using a Cooperative Dictionary, by Franaszek et al., filed on Jul. 6, 1995 (“Franaszek”). The Franaszek patent is commonly assigned with the present invention to IBM Corporation, Armonlc, N.Y. and is hereby incorporated herein by reference in its entirety.

Currently, memory compression increases the capacity of main store, yet operates transparently to software. Compression allows physical memory to be overcommitted by a factor of two, depending upon compressibility of memory contents. If compressibility deteriorates, the O/S must pageout some of the contents and ensure that physical space does not become exhausted.

To date, compression management has been developed only for the case of a stand-alone Operating System. What is needed is a way to provide compression management for Virtualized Systems.

### SUMMARY OF THE INVENTION

Embodiments of the present invention provides a system and method for managing compression memory in a computer system. Briefly described, in architecture, one embodiment of the system, among others, can be implemented as follows. This system includes a hypervisor having means for identifying a OS having a plurality of memory pages allocated, means for counting the number of a plurality of memory pages allocated, and means for counting a number of free space pages in the compressed memory. The hypervisor further includes means for determining if the number of free space pages is less than a predetermined threshold, and means for increasing the number of free space pages if less than a predetermined threshold.

Embodiment of the present invention can also be viewed as providing methods for managing memory compression in a computer system. In this regard, one embodiment of such a method, among others, can be broadly summarized by the following steps. The method for managing memory compression in a computer system includes (1) identifying a OS having a plurality of memory pages allocated; (2) counting the number of a plurality of memory pages allocated; (3) counting a number of free space pages in the compressed memory; (4) determining if the number of free space pages is less than a predetermined threshold; and (5) increasing the number of free space pages if less than a predetermined threshold. Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a computing system 100 incorporating the compressed memory management capability of the present invention.

FIG. 2 illustrates one example of the real vs physical memory & hypervisor management.

FIG. 3 illustrates one example of a method for managing memory of a guest operating system in accordance with the hypervisor of the present invention.

FIG. 4 illustrates one example of a method for managing memory of an entire computing environment in accordance with the hypervisor of the present invention.

The detailed description explains the preferred embodiments of the invention, together with advantages and features, by way of example with reference to the drawings.

### DETAILED DESCRIPTION OF THE INVENTION

The invention addresses problems with managing memory compression in a virtualized computer system. The application of the presented method.

Just as ‘virtual memory’ allows ‘real memory’ to be over-committed, memory compression allows real memory to over-commit ‘physical memory’. However, physical memory usage varies by the compressibility of the data it contains. Computation alone may quickly change physical memory usage (though in practice, compressibility of data for a given application tends to be static). Physical memory free space must be continually monitored and managed to avoid exhaustion. References that describe the managing memory compression include the following patents, patent applications and publications, incorporated herein by reference: U.S. Pat. No. 7,024,512 to Franaszek et al., issued Apr. 4, 2006, entitled “Compression store free-space management”; U.S. Pat. No. 6,889,296 to Franaszek et al., issued May 3, 2005, entitled “Memory management method for preventing an operating system from writing into user memory space”; U.S. Pat. No. 6,681,305 to Franke et al., issued Jan. 20, 2004, entitled “Method for operating system support for memory compression,”, U.S. Pat. No. 6,877,081 to Herger et al., issued Apr. 5, 2005, entitled “System and method for managing memory compression transparent to an operating system”; U.S. Pat. No. 6,847,315 to Castelli et al., issued Jan. 25, 2005, entitled “Nonuniform compression span,”; U.S. Pat. No. 6,842,832 to Franaszek et al., issued Jan. 11, 2005, entitled “Reclaim space reserve for a compressed memory system”; U.S. Pat. No. 6,804,754 to Franaszek et al., issued Oct. 12, 2004, entitled “Space management in compressed main memory”; U.S. Pat. No. 6,681,305 to Franke et al., issued Jan. 20, 2004, entitled “Method for operating system support for memory compression”; and U.S. Pat. No. 6,279,092 to Franaszek et al., issued Aug. 21, 2001, entitled “Kernel identification for space management in compressed memory systems”.

In the case of virtualized systems, a hypervisor is ideally suited to monitor physical memory usage of guest O/Ss, adjusting memory usage and scheduling when necessary. Also guest O/Ss may be migrated to balance physical memory usage across multiple systems. By running the hypervisor, DomO, I/O Doms or VMWare Server in uncompressed memory, guaranteed forward progress (GFP) issues are largely avoided. (GFP: accounting for an increased physical memory usage that may occur while trying to reduce physical usage. See, for example, “Algorithms and data structures for compressed memory machines”, Franaszek, et al., IBM JRD, vol 45, no 2) which is hereby incorporated by reference in its entirety.

Virtualized Systems' include systems with virtualization provided by the hypervisor, such as Xen, or by a complete server, such as VMWare's ESX. In these systems, the hypervisor or ESX Server, manages the physical resources, VMWare already supports over commitment of real memory. Whenever a Virtual Machine is initiated, it is assigned a memory size. The sum of the VM memory sizes may exceed the size of real memory. ‘Balloon’ drivers are used inducing the Guest O/Ss to pageout as memory pressure increases. Also the ESX Server will provide paging at a global level, if necessary.

In non-virtualized systems, the O/S, together with drivers and services, manages all resoruces, including physical memory. In virtualized systems, the hypervisor, together with DomO/VMWare Server, manages physical memory. Physical memory management in a virtualized system includes additional dimensions, such as: a) Balancing physical memory among guest O/Ss running on a single system—readjusting watermarks while system has ample physical space. b) Balancing physical memory usage across multiple systems, migrating O/Ss when necessary.

Hardware should provide means to monitor physical memory usage per guest O/S; for example ‘free space’ registers and watermark interrupts. When free space runs low, following steps may be taken (depending on whether guest O/S is ‘compression-aware’, and depending on rate of recovery): cf ‘IBM Memory Technology (MXT)’, Tremaine, et al, IBM JRD, vol 45, no 2.

Managing memory compression includes similar mechanisms. However, there are additional considerations: (1) Free physical space continually varies as a function of data compressibility. For example, with no further memory allocations, free space may become exhausted when the contents of an array is changed from highly compressible to incompressible. Physical space needs to be constantly monitored. (2) Space recovery via balloon drivers may be inadequate; (a) Paging out highly compressible data will recover no space, and could even consume additional space to support pageout activity. (b) Space recovery with ballooning does not keep pace with space consumption. In these cases, the problematic VMs need to be curtailed while paging proceeds through other VMs and/or hypervisor/server. (3) GFP: The hypervisor server needs to be run in a memory space with compression off, ensuring that its paging out operation will not consume additional memory. (4) Finally, buffers reserved for incoming I/O must also be fully backed by physical memory. Incoming data may be incompressible, so worse-case physical memory must be reserved, I/O cannot be halted midstream while more physical memory is found.

A preferred implementation follows the layout as described in Tremaine et. al. in the above referenced paper. Cache lines are decompressed/compressed respectively on storage/access to and from main memory. Such accesses occur on cache writebacks and fetches respectively. The system includes a translation table (not shown), and a means for keeping track of free space (not shown), which is allocated in units or sectors of 256B.

The system monitors overall memory usage by keeping track of the number of free sectors, and it also monitors guest OS usage by maintaining a count of the number of occupied sectors allocated to each guest OS. The former is done via hardware counters.

The OS guest usage would be maintained by identifying the requesting OS at the time of a sector allocation and deallocation. This means adding sufficient bits to the entries in the translation table to be able to determine which OS owns a particular page. When a cache line is stored back to memory, the translation table is addressed, and if the number of sectors used is changed, the number of allocated sectors for the identified OS is updated.

To ensure that ‘suspend’ halts additional physical memory consumption, ‘space reservations’ must be made for guest I/O buffers, data structures and areas updated via hypervisor. Also ‘memory footprint’ for suspend operation must be permanently reserved.

While a balloon driver is useful in managing physical space for a ‘compression-unaware’ guest O/S, there is no mechanism for slowing or suspending the guest's applications. This type of guest may be suspended while adequate physical space is recovered from other guests, or it may be migrated to another system if its space requirements grow too large.

Thresholds are maintained for overall memory utilization and utilization by each guest OS. Actions taken include:
a) If overall free space below some threshold: Choose one or more guest OS, and transfer its pages to secondary storage.
b) If usage by an OS greater than some threshold: Force it to restrict the number of pages it has in memory.
c) If usage is below some threshold, permit one or more OSs to increase the number of pages they have in memory.

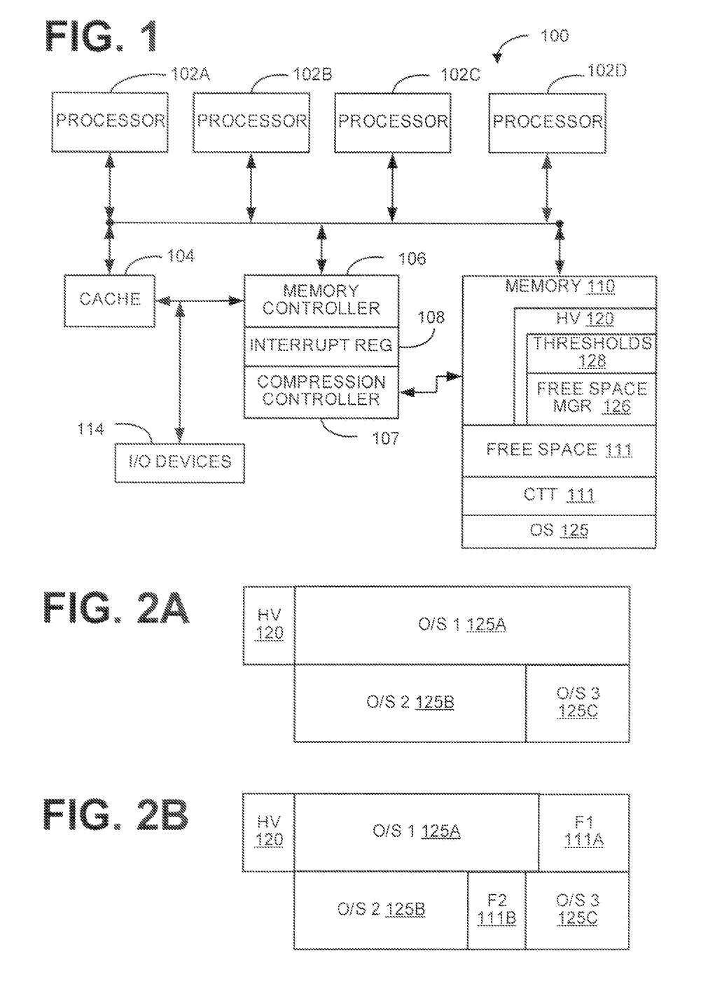

FIG. 1 depicts one example of a block diagram of a computing system 100 incorporating the compressed memory management capability of the present invention. In one embodiment, the computing system 100 includes a large server system, which except for the memory controller 106 (described below) is offered by International Business Machines Corporation. As depicted, the computing system 100 includes, for example, one or more processors 102, operating system (OS) 125, a cache 104, a memory controller 106, interrupt registers 108 and one or more input/output (“I/O”) devices 114, each of which is described in detail below. Data in memory 110 is compressed and data in cache 104 is uncompressed. Cache lines are compressed/decompressed as they move to/from memory 110, transparently to software. Also management of the compressed data sectors and free space is performed entirely by hardware. Memory extension technology (MXT) is an example of the type of hardware that could be managed by the hypervisor described in this disclosure. MXT is a trademark of IBM Corporation.

As is known, processor(s) 102 are the controlling center of the computing system 100. The processor(s) 102 execute at least one operating system (OS) 125 which controls the execution of programs and processing of data. Examples include but are not limited to an OS such as IBM z/OS™, Z/VM™, AIX™ operating systems, WINDOWS NT™ or a UNIX™ based operating system such as the Linux™ operating system (z/OS, z/VM and AIX are trademarks of IBM Corporation; WINDOWS NT is a registered trademark of Microsoft Corporation; UNIX is a registered trademark of The Open Group in the United States and other countries; Linux is a trademark of Linus Torvalds in the United States, other countries, or both). As described below, the OS 125 is one component of the computing system 100 that can incorporate and use the capabilities of the present invention.

Coupled to the processor(s) 102 and the memory controller 106 described below) is a cache 104. The cache 104 provides a short term, high-speed, high-capacity computer memory for data retrieved by the memory controller 106 from the I/O devices 114 and/or the main registers.

Coupled to the cache 104 and the compressed memory is the memory controller 106, (described in detail below) which manages, for example, the transfer of information between the I/O devices 114 and the cache 104, and/or the transfer of information between the main memory and the cache 104. Functions of the memory controller 106 that includes a compressor/decompressor 107 for compression and decompression of data; and the storing of the resulting compressed lines in blocks of fixed size. This preferably includes a mapping from real page addresses, as seen by the OS 125, to addresses of fixed-size blocks in memory.

The compressed memory, which is also coupled to the memory controller 106 and compressor/decompressor 107, contains data which is compressed, for example, in units of cache lines. In one embodiment, each page includes four cache lines. Cache lines are decompressed and compressed respectively when inserted or cast-out of cache 104. Pages from I/O devices 114 are also compressed (in units of cache lines) on insertion into main memory (not shown). In this example, I/O is done into and out of the cache 104. Although a single cache is shown, for simplicity, an actual system may include a hierarchy of caches.

As is well known, information relating to pages of memory can be stored in one or more page tables in memory 110 or the cache 104 and is used by the OS 125. The real address of a page is mapped into a set of physical addresses (e.g., identifiers of blocks of storage) for each cache line, when the page is requested from memory 110. In one example, this is accomplished using tables. These tables can be accessed by the memory controller 106. Tables includes, for instance, what is termed the real page address for a page as well as a list of the memory blocks for each line of the page. For example, each page could be 4 k bytes in size and includes four cache lines. Each cache line is 1 k bytes in size.

Compressed cache lines are held in fixed-size blocks of 256 bytes, as one example. The table includes, for instance, the compressed blocks making up a particular line of a page. For example, a line of a page is stored in three blocks, each having 256 bytes. Since, in this example, each page can include up to four cache lines and each cache line can include up to four compressed blocks of memory, each page may occupy up to 16 blocks of memory.

Referring again to the system depicted in FIG. 1, in accordance with the present invention, the memory controller 106 can include one or more interrupt registers 108 and can access a free-space list held in main memory. One implementation of the free-space list is as a linked list, which is well known to those of skill in the art. Here, the memory controller 106 performs various functions, including: a) Compressing lines which are cast out of the cache 104, and storing the results in some number of fixed-size blocks drawn from the free-space list; b) Decompressing lines on cache 104 fetches; c) Blocks freed by operations such as removing a line from memory 110, or compressing a changed line which now uses less space, are added to the free-space list 112; d) Maintaining a count F of the number of blocks on the free-space list. This count is preferably available to the OS 125 on request; e) Maintaining a set of thresholds implemented as interrupt registers (108) on the size of F. Changes in F that cause thresholds to be crossed (described in detail below) cause a processor interrupt.

Preferably, each threshold can be dynamically set by software and at least those related to measured quantities are stored in an interrupt register 108 in the memory controller 106.

The free-space manager 126 in hypervisor 120 maintains an appropriate number of blocks on the free-space list. Too few such blocks causes the system to abend or suspend execution of applications pending page-outs, while having too many such blocks is wasteful of storage, producing excessive page faults. The free-space manager 126 also sets the interrupt registers 108 with one or more thresholds (T0 . . . TN) at which interrupts are generated. As stated, threshold values which are related to actual measured values, as opposed to periodically measured values, are stored in one or more interrupt registers 108.

Those skilled in the art will appreciate that there are various alternative implementations within the spirit and scope of the present invention. For example, various functions embodied in the memory controller 106 can be performed by other hardware and/or software components within the computing system 100. As one example, the compressed memory management technique can be performed by programs executed by the processor(s) 102.

In a system without memory compression, the allocation of a page to a program by the operating system corresponds exactly to the granting of a page frame. That is, there is a one-to-one correspondence between addresses for pages in memory and space utilization. This is not the case here, since each line in a page can occupy a variable number of data blocks (say 0, to 4 as an example). Moreover, the number of blocks occupied by a given line may vary as it is modified.

A difference between the operation of the current system and a conventional one is that there will in general be a delay between granting a page, and its full utilization of memory. Failure to account for such delayed expansion can mean an over commitment of memory space and an increased likelihood of rapid expansion. The result may be an oscillation between granting too many pages and halting all processing while the resulting required page-outs are pending. The present invention avoids such compression-associated memory thrashing.

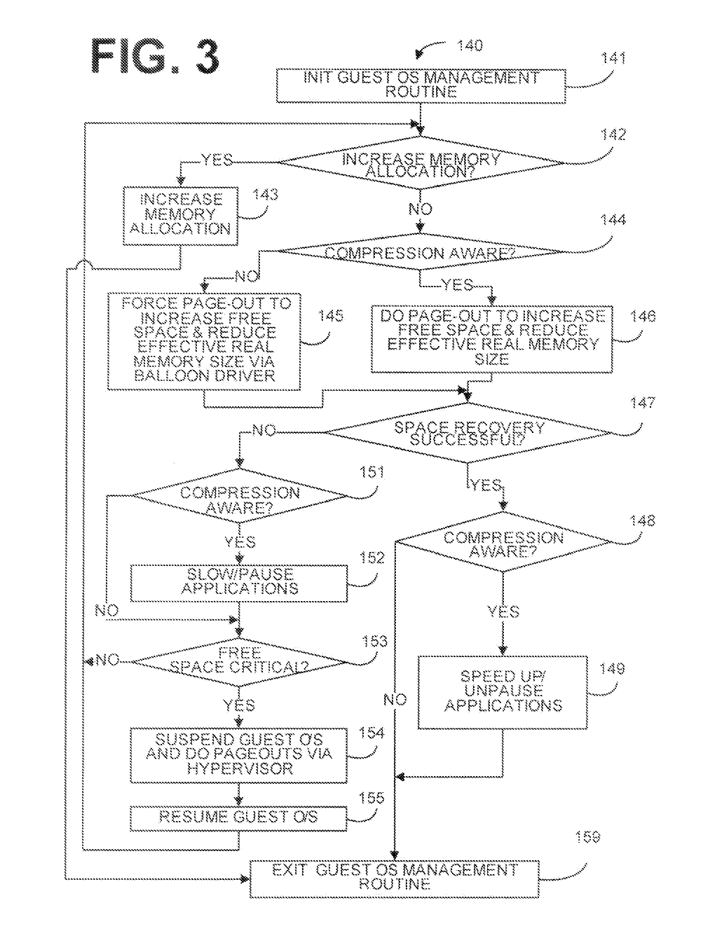

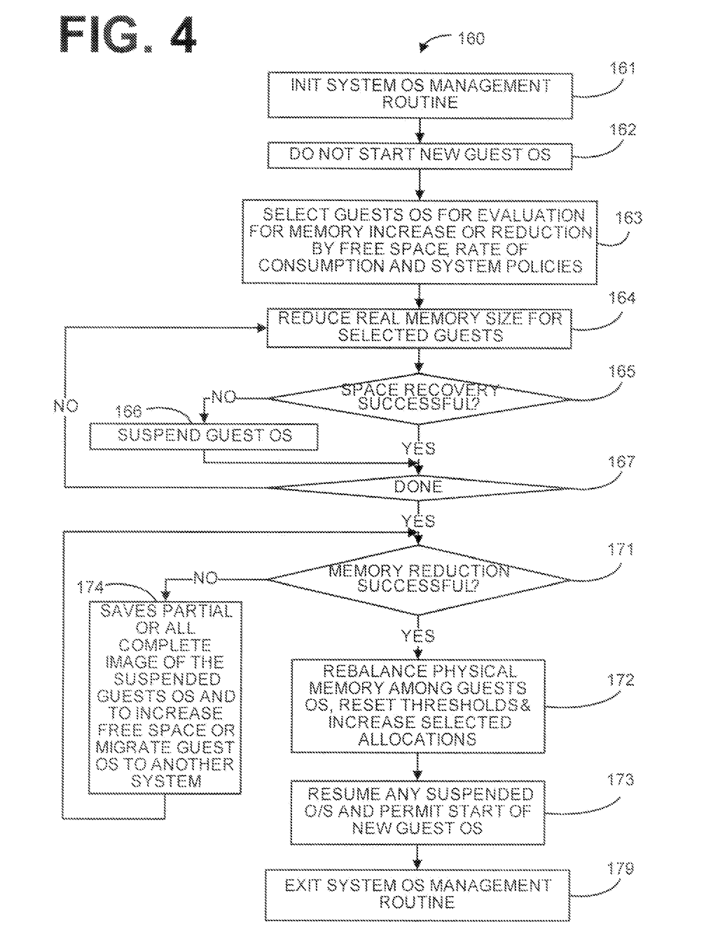

FIGS. 2A and 2B illustrates one example of the real (FIG. 2A) vs physical memory (FIG. 2B) & hypervisor 120 management. The figures contrast ‘real memory’ usage with ‘physical’ usage. That is, FIG. 2A illustrates the amount of real memory used. FIG. 2b shows the amount of physical memory used. The hypervisor 120 is not compressed, and consuming the same amount of physical memory as real memory. O/S 1 125A and O/S 2 125B are compressing with free spaces 1F and 2F. O/S 3 125C is compressing poorly and needs extra space. At this point the hypervisor 120 would be talking steps outlined in FIGS. 3 and 4, to reduce physical memory usage by O/S 1 and O/S 2, and grant additional space to O/S 3.

FIG. 3 illustrates one example of a method for managing memory of a guest operating system in accordance with hypervisor 120 of the present invention. The guest OS management routine 140 is triggered by a hardware interrupt when a threshold setting for the memory free space traverses a threshold.

First, the guest OS management routine 140 is initialized at step 141. The initialization includes the establishment of data values for particular data structures utilized in the guest OS management routine 140. It is determined at step 142 if it is possible to increase the memory allocation. If it is determined that it is not possible to increase the memory allocation, then the guest OS management routine 140 then proceeds to step 144. However, if it is determined at step 142 that an increase in memory allocation is possible, then the guest OS management routine 140 is provided in step 143 with parameters for how many additional pages it can store in memory. The increase of memory allocation can be accomplished either by the guest OS management routine 140 if the guest OS being evaluated is compression aware. However, if it is the determined that the guest OS being evaluated is not compression aware, then the guest OS management routine 140 utilizes a balloon driver to increase the memory allocation at step 143. This is done by having the balloon driver release some pinned pages. After the memory allocation has been increased, the guest OS management routine 140 proceeds to step 159.

At step 144, it is determined if the guest OS is ‘compression-aware’. If it is determined at step 144 that the guest OS is compression aware, guest OS does a page out to increase free space. The guest OS management routine 140 then skips to step 147.

However, if it is determined at step 144 that the guest OS is not compression aware, the guest OS management routine 140 forces page outs, via a balloon driver (or ‘hot-unplug’), to increase free space at step 146. This driver allocates, pins and zeros pages, removing them from further usage. Page outs include for example, but are not limited to reducing disk cache size or ‘standby page list’. The guest OS management routine 140 also asks that pages be zeroed as soon as they are freed.

At step 147, it is then determined if the space recovery process was successful. If it is determined at step 145 that the space recovery process was not successful, then the guest OS management routine 140 proceeds to step 151.

However, if it is determined at step 147 that the space recovery process was successful, then the guest OS management routine 140 then determines whether the guest OS is compression aware, at step 148. If it is determined in step 148 that the guest OS was not compression aware, then the guest OS management routine 140 then exits at step 159. However, if it is determined at step 148 that the guest OS was compression aware, then the guest OS management routine 140 then speeds up the guest OS processes and unpauses any paused applications at step 149. The guest OS management routine 140 then exits at step 159.

At step 151, the guest OS management routine 140 then determines whether the guest OS is compression aware. If it is determined at step 151 that the guest OS was not compression aware, then the guest OS management routine 140 slips to step 153. However, it is determined at step 151 that the guest OS was compression aware, then the guest OS management routine 140 then slows or pauses any applications with regard to the guest OS being evaluated at step 152.

At step 153, the guest OS management routine 140 determines if the free space situation is critical. If it is determined at step 153, that the free space situation is not critical, then the guest OS management routine 140 then returns to step 144. However, if it is determined at step 153 that the free space situation is critical, the guest OS management routine 140 suspends the guest OS and pages out any data using the hypervisor 120 at step 154. At step 155, the guest OS management routine 140 then resumes the guest OS and returns to step 142.

FIG. 4 illustrates one example of a method for managing memory of an entire computing environment in accordance with the hypervisor 120 of the present invention. The system OS management routine 160 is triggered by a hardware interrupt when a system threshold setting is crossed for the amount of system memory free space.

First, the system OS management routine 160 is initialized at step 161. The initialization includes the establishment of data values for particular data structures utilized in the system OS management routine 160. At step 162, system OS management routine 160 does not allow new guest O/Ss to be started. At step 163, the system OS management routine 160 then selects guest O/Ss for physical memory reduction or increase, based on free physical space, physical space (i.e. consumption rate), and administrative policies. If physical space utilization is increased, this is done simply by resetting the thresholds. If physical space utilization is to be decreased, then step 164 is initiated.

At step 164, the system OS management routine 160 then reduces CPU resources for certain guests OS by reducing physical space usage. At step 165 the system OS management routine 160 then determines if physical memory reduction for the guest OSs being evaluated were successful. If it is determined to step 165 that the physical memory reduction for the guest OS being evaluated was successful, then the system hypervisor routine then skips to step 167. However, if it is determined that step 165 that the physical memory reduction for the guest OS being evaluated was not successful, then the system OS management routine 160 then suspends the guest OS by saving part or all of its image to disk, and zeroing freed pages. Steps 164-167 maybe done in parallel for all selected guest OSs in alternative embodiment. To ensure that ‘suspend’ halts additional physical memory consumption, ‘space reservations’ is made for guest I/O buffers, data structures and areas updated by system OS management routine 160 via hypervisor 120. Also ‘memory footprint’ information for suspend operation maybe permanently reserved.

At step 167, it is determined if there are more guest OSs to be evaluated. If it is determined at step 167 that there are no more guest OSs to be evaluated, then the system OS management routine 160 skips to step 171. However, if it is determined at step 167 that there are more guest OSs to be evaluated, and the system OS management routine 160 returns to repeat steps 164 through 167.

At step 171, it is determined if the physical memory reduction was successful for the overall system. If it is determined at step 171 that the physical memory reduction or increasing was successful, then the system OS management routine 160 rebalances the physical memory among the guest OSs by resetting thresholds at step 172. At step 173, the system OS management routine 160 then resumes any suspended guests OSs and then exits at step 179.

However, if it is determined at step 171 that the physical memory reduction was not successful for the entire system, then the system OS management routine 160 then saves the partial or complete images of the suspended guests OS and zeros any freed pages resulting from the saving of the image at step 174. The system OS management routine 160 then determines if the suspended guests OS can be migrated to another system at step 174. If it is determined that the suspended guests OS can not be migrated, then the system OS management routine 160 returns to step 171. However, if it is determined that the suspended guests OSs can be migrated, then the data for the guest OS is packaged and migrated to another system. The system OS management routine 160 then returns to step 171.

The present invention can take the form of an entirely hardware embodiment, an entirely software embodiment or an embodiment containing both hardware and software elements. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

In an alternative embodiment, where the hypervisor 120 is implemented in hardware, the hypervisor 120 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Furthermore, the invention can tale the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A hypervisor for managing a compression memory in a computer system, the hypervisor comprising:
means for identifying a operating system (OS) having a plurality of memory pages allocated;
means for counting the number of the plurality of memory pages allocated;
means for counting a number of free space pages in the compressed memory;
means for determining if the number of free space pages is less than a predetermined threshold; and
means for increasing the number of free space pages if less than a predetermined threshold.

2. The system of claim 1, further comprising:
means for reducing the number of the plurality of memory pages allocated for the OS.

3. The system of claim 1, further comprising:
means for increasing the number of the plurality of memory pages allocated for the OS.

4. A method for managing a compressed memory in a computer, comprising:
identifying a operating system having a plurality of memory pages allocated;
counting the number of the plurality of memory pages allocated;
counting a number of free space pages in the compressed memory;
determining if the number of free space pages is less than a predetermined threshold; and
increasing the number of free space pages if less than a predetermined threshold.

5. The method of claim 4, wherein the increasing step further comprises reducing the number of the plurality of memory pages allocated for the OS.

6. The method of claim 4, wherein the increasing step further comprises:
increasing the number of the plurality of memory pages allocated for the OS.
